(19) United States
(12) Patent Application Publication
(10) Pub. No.: US 2005/0082021 A1
(43) Pub. Date: Apr. 21, 2005

(54) Sliding screen door closer

(76) Inventor: Brandon Lee Manning, Shawnee, KS (US)

Correspondence Address: BRANDON MANNING, 6400 BROCKWAY, SHAWNEE, KS, 66226, US

(21) Appl. No.: 10/688,957

(22) Filed: Oct. 21, 2003

(51) Int. Cl. E06B 9/52

(52) U.S. Cl. 160/371

(57) ABSTRACT

The subject of the invention is an automatic sliding screen door closer. This invention utilizes a generic, pneumatic cylinder type door closer in conjunction with a swinging arm to apply a closing force to the sliding screen door. The door closer is mounted to the exterior of the building either above or below the sliding door opening and provides the closing force to move the swinging arm. The free end of the swinging arm caries a roller, which rides against a track secured to the sliding screen door.

### BACKGROUND OF THE INVENTION

1. Field of Invention

The Field of invention relates to door closers and more specifically a door closer for use with a sliding screen door. Such a device provides an automatic means of returning the sliding screen door to the fully closed position after being opened by someone passing through the doorway.

2. Description of the Prior Art

Sliding door assemblies consisting of a sliding glass door, a stationary glass panel, and a sliding screen door encompassed by a tracked frame to allow for movement of both the sliding glass door and the sliding screen door are common to a variety of different houses and other structures. Such sliding doorways often provide access to a patio, porch, or deck and as a result become a high traffic area and are subject to frequent use. In moderate climates and pleasant weather it may be desirable to keep the sliding glass door open to allow for circulation of air within the house or other structure, and yet keep the sliding screen door closed to maintain a reasonable level of insect control. Due to the nature of the high traffic area and frequent use of the sliding screen door it may be left open by persons passing through the doorway and thus allow insects and other pests to enter the house or structure.

Johnson, U.S. Pat. No. 4,126,912 discloses a means to accomplish the same objective through use of a weight and gravity along with a pulley system to automatically close a sliding door.

Munton, U.S. Pat. No. 6,578,320 discloses a means to similarly close a sliding door by use of a closer with a rotating drive shaft much different than that in the present invention.

This invention distinguishes itself over the prior art by using a generic cylindrical type door closer in conjunction with a swinging arm and roller to apply a closing force to the sliding door via a track secured to the sliding screen door. The aforementioned generic door closer such as that commonly available for use with hinged screen or storm doors and having at a minimum, a cylindrical housing which encloses a spring, a piston and an adjusting means for controlling the rate at which closer operates functions not only to close the door but also to dampen the movement of the opening and closing of the door allowing for smooth operation. This invention through the use of leverage allows for the use of less effort to open the sliding screen door than similar inventions.

### BRIEF SUMMARY OF THE INVENTION

It is the object of this invention to provide a means to automatically close a sliding screen door and to do so in a smooth and quiet manner without requiring the use of electricity or batteries. Such device must require minimal additional opening force above and beyond that required in opening a similar but unequipped sliding screen door.

### BRIEF DESCRIPTION OF THE DRAWINGS

FIG. 1 depicts an exterior elevation of a sliding screen door fitted with the sliding screen door closer apparatus.

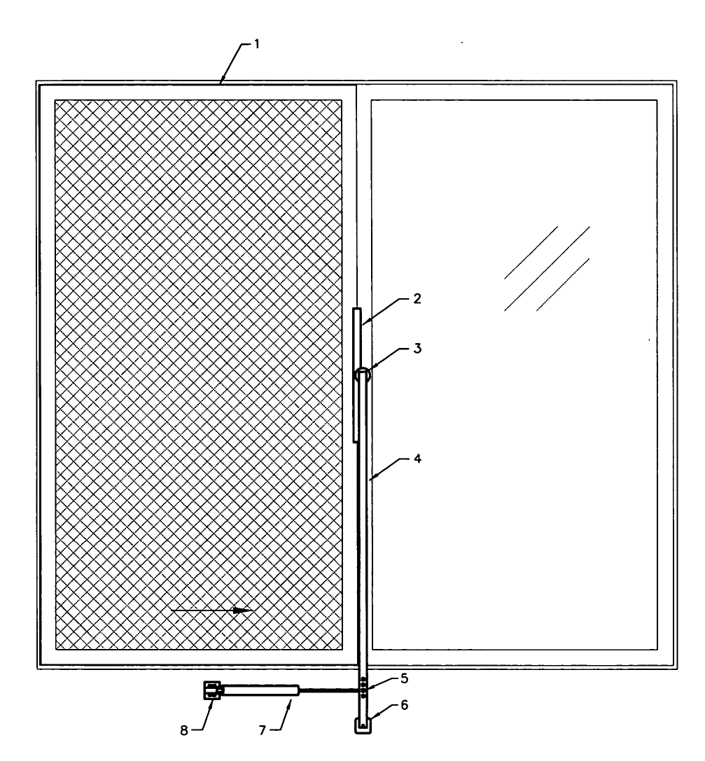

### DESCRIPTION OF THE PREFERRED EMBODIMENT

Referring to the drawing, there is shown a conventional sliding screen door 1 having rollers on the top and the bottom to allow the door to travel within a track built into the sliding door frame. Such a frame commonly houses both a sliding glass door and a stationary glass panel as well as the sliding screen door, however this invention only concerns itself with the sliding screen door portion of the sliding glass door assembly.

Secured to the edge of the sliding screen door 1 opposite the opening is a track 2 attached approximately midway up the vertical length of the door. The track 2 shall be constructed out of a durable, weather resistant material such as aluminum and may be painted to match the color of the sliding screen door 1. The track 2 requires no special features other than to be: (a) stiff to distribute the force applied by the swinging arm and roller to the door, (b) be of a durable material such as to allow for many uses with minimal wear. Said track's primary purpose is to guide and contain a roller 3 attached to the swinging arm 4. The roller 3 shall be compatible with the track 2 and may be constructed out of plastic, metal, or other durable weather resistant material. The roller 3 is then allowed to ride up and down the length of track 2 while the sliding screen door 1 is being open and closed. The swinging arm 4 supports the roller 3 and provides the movement necessary to close the sliding screen door 1. The swinging arm 4 is anchored to the structure at one end and the other end is allowed to move freely carrying the roller 3 with it. The swinging arm 4 shall be of sufficient length to reach to the track 2. The swinging arm 4 shall be constructed of a stiff weather resistant material such as aluminum and may be painted to match the color of the door and shall have a number of adjustment holes 5 near the pivot end to allow for varying degrees of closing force from the generic closer 7 to be applied to the swinging arm 4. The generic closer 7 shall be similar to that used for hinged screen doors and shall meet the minimum requirements listed above. The closer's retracting piston 7 is attached to swinging arm 4 by means of a bolt or pin through one of the adjustment holes 5. The body of the closer 7 is secured to the structure by means of the closer support bracket 8. The closer support bracket 8 supports the closer 7 and is secured to the structure with screws. The closer support bracket 8 shall be constructed of a sturdy weather resistant material such as aluminum and provides further adjustment by means of slotted screw holes for the mounting screws that secure it to the structure. The mounting block for the swinging arm 6 is also secured to the structure and provides a fixed pivot point and the correct spacing away from the structure for the swinging arm 4. The mounting block for the swinging arm 6 shall be constructed out of a durable weather resistant material such as plastic.

1. A sliding screen door closer for use with sliding screen doors, having a length of track secured to the sliding screen door opposite the opening, a roller compatible with the track secured to a swinging arm of suitable length which pivots back and forth from its mounting block and transmits the force applied by a generic door closer attached to one of its adjustment holes into a swinging motion, a fixed mounting block to support the swinging arm and an adjustable bracket to support the generic door closer.
